(19) United States
(12) Patent Application Publication
(10) Pub. No.: US 2019/0374968 A1
(43) Pub. Date: Dec. 12, 2019

(54) PAINT VENTILATION AND ROTATION SYSTEM FOR ARTISTIC RENDERINGS

(71) Applicant: Ann Mong, Las Vegas, NV (US)

(72) Inventors: Ann Mong, Las Vegas, NV (US); Hiroshi Rodriguez, Las Vegas, NV (US)

(73) Assignee: Visual Art Images, Inc., Las Vegas, NV (US)

(21) Appl. No.: 16/436,831

(22) Filed: Jun. 10, 2019

Related U.S. Application Data
(60) Provisional application No. 62/683,974, filed on Jun. 12, 2018.

(51) Int. Cl. B05B 14/30

(52) U.S. Cl. CPC B05B 14/30

(57) ABSTRACT

An apparatus of a paint rotational tool or device designed to eliminate excess fumes through a robust ventilation system and method for use of the same. A device and system comprised of an artist medium secured to a paint board, attached to a rotational filter apparatus connected to a ventilation system comprised of a novel design of air-flow piping tubes, motor to produce suction and a remote ventilation apparatus.

### CROSS-REFERENCE TO RELATED APPLICATIONS:

62/683,974—Provisional patent application filed Jun. 12, 2018

### FEDERALLY SPONSORED RESEARCH

None

### SEQUENCE LISTING

None

### TECHNICAL FIELD OF INVENTION (FOI)

This present disclosure claims the priority of U.S. Provisional Application 62/683,974, filed on Jun. 12, 2018 and relates to tools or devices for painting and controlling fumes of an artist during the painting process specifically related to spray paint utilized during street or public performances and artistic renderings before a crowd or in a confined space. More specifically, this invention relates to a single user tool to ventilate spray paint on a rotating board to produce a work of art or artist rendering in public.

### BACKGROUND

It is common for individual artists to produce a variety of art in a variety of settings. Sometimes, individuals choose to create art in a public setting such as in an entertainment venue or at a fairground. In this context, the artist performs their work quickly while permitting bystanders to watch. A common form of this activity involves aerosolized paint and a spinning board. The artist uses a combination of different colors of aerosolized paint, shaping tools, and the spinning motion of the paint board to produce unique art and entertain in the process. As the artist produces their work, the bystanders as well as the artist are subject to excess paint and fumes, causing an unpleasant experience for some individuals. These byproducts can cause problems to sensitive individuals with breathing problems such as asthma. Additionally, some spectators or customers do not like the strong odor associated with the aerosolized paint. It is therefore an object of the present invention to eliminate the danger and unpleasantness of these byproducts.

A variety of tools, devices, and methods have been developed to aid ventilation in painting. It is a common problem addressed in industrial and commercial activities. However, each of these tools is ill suited for an individual painter because of their cost, size, and imprecise application. In the context of art, there is a need for an individual paint board ventilation system that maintains the traditional functionality of a personal art board while simultaneously increasing ventilation to eliminate bothersome and potentially harmful aerosolized byproducts.

For example, Josefsson U.S. Pat. No. 4,537,120 discloses a ventilation system for a paint spray both whereby a plurality of walls of air separate different zones for a large scale paint spray application. In yet another example, Neikter U.S. Pat. No. 5,296,029 discloses a similar ventilation system for a spraying booth. These inventions are costly and immobile with its application in the industrial sector for products such as cars, ill-suited for individual artists.

It can be seen, therefore, that there is a tool or device needed in art production to enable a single user to maintain functionality of the spinning paint board while increasing the safety and enjoyment for the artist, customer, and spectators.

### SUMMARY

The present disclosure relates to a novel design of a spray paint rotational tool or device designed to eliminate excess fumes through a robust ventilation system and method for use of the same. In the preferred embodiment, the device is comprised of a paint board, a filter container affixed to the paint board, and a ventilation system.

The paint board is a hollow box comprised of material common known in the art, such as wood, aluminum, or other material sufficiently light and durable to permit rotation along a central axis and support the desired art or craft. This box has a plurality of apertures on the surface of the hollow box surrounding the desired shape of the art craft. On the underside of the box, a single or plurality of apertures with a lip extending beyond the underside of the hollow box circumnavigating each aperture sits on top a filter container, permitting three hundred and sixty degree rotation, enabling a user to remain stationary and apply paint to the art or craft from a variety of angles.

The filter container is an airtight hollow hyper-rectangle comprised of a means of receiving the plurality of apertures on the underside of the hollow box, a plurality of bearings on the upward facing surface of the filter container, a filter holding apparatus, and a plurality of apertures on the underside of the filter container configured to receive a tube or hose or plurality thereof. The filter container, in the preferred embodiment, is generally rectangular in shape, with an upward facing surface, four walls, and a downward facing surface. The upward facing surface is flat with a plurality of ball bearings affixed to the outward facing surface designed to come into contact with the paint board. The ball bearings permit rotation of the paint board in a circular motion and reduce friction between the filter container and the paint board. The upward facing surface has an aperture or plurality of apertures slightly larger than those presented on the underside of the paint board to permit the lip of each aperture to fit inside. The filter holding apparatus is comprised of a plurality of brackets at the midpoint between the upward facing surface and the downward facing surface. These brackets are configured to receive a filter, or alternatively, a wire mesh board which a filter can then be placed on top of. The underside of the filter container contains one or more apertures configured to receive a tube or hose. The seal is airtight permitting suction force down through the paint board, the filter container, and into the hose.

The ventilation system is comprised of a plurality of tubes or hoses connected to a suction motor, a dilution fan, and a terminal exhaust port. The tubes or hoses affix to the underside of the filter container and continue to the suction motor. The suction motor is comprised of a generic or common use motor and fan apparatus designed to move air toward the dilution fan and terminal exhaust port, creating a negative air pressure causing the ambient air in the paint board and filter container to move towards the dilution fan and terminal exhaust port. The suction motor is connected to the dilution fan through another tube or hose. The dilution fan is a generic fan system designed to create a second negative air pressure point between the suction motor and the dilution fan to eject fumes drawn in from the ventilation system. The dilution fan is directly connected to the terminal exhaust port where the air is ultimately expelled.

This summary is not intended to identify key features or essential features of the claimed subject matter, nor is it intended to be used as an aid in determining the scope of the claimed subject matter.

Additional features and advantages of exemplary implementations of the present disclosure will be set forth below, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF DRAWINGS

An embodiment of the present invention will hereinafter be described in conjunction appended drawings,provided to illustrate and not to limit the invention. Drawings included in this Provisional Patent Application are illustrative of the present disclosure, method, and designs but said drawings will be amended in the anticipated Non-Provisional Application. The Figure descriptions below s the drawing intent and objective but do not relate specifically to any current drawing or embodiment of the present invention and the inventor reserves the right to update, modify, amend or revoke any of the depicted drawings in anticipation of a Non-Provisional Patent Application.

FIG. 1 illustrates a diagram of a side and overhead perspective view of the paint board with the indicated flap depicting the location of the artist medium such as paper, wood or canvass.

FIG. 2 illustrates a diagram of an underside perspective view of the paint board with a central cut-away in a circle for the purpose of air flow during the painting process and ventilation.

FIG. 3 illustrates a diagram of a side perspective view of the paint board and filter container configured to receive the paint board shown in a three level construction with fasteners for the board, ventilation tubing and grating for airflow.

FIG. 4 illustrates a diagram of the rotational movement of the paint board and filter when attached to the ventilation system during the artistic rendering.

FIG. 5 illustrates a schematic of the paint board, filter container, and ventilation system with hypothetical arrows to indicate airflow during the ventilation process.

### DETAILED DESCRIPTION OF DRAWINGS

This present disclosure will be described in detail with reference to embodiments thereof as illustrated in the accompanying drawings and figures, in which like reference numerals are used to indicate identical or functionally similar elements. References to “one embodiment”, “an embodiment”, “an example embodiment”, etc., indicate that the embodiment described may include a particular feature, structure, or characteristic, that every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following examples are illustrative, but not limiting, of the present invention. Other suitable modifications and adaptations of the variety of conditions and parameters normally encountered in the field, and which would be apparent to those skilled in the art, are within the spirit and scope of the invention.

It will be understood that like or analogous elements and/or components, referred to herein, may be identified throughout the drawings with like reference characters.

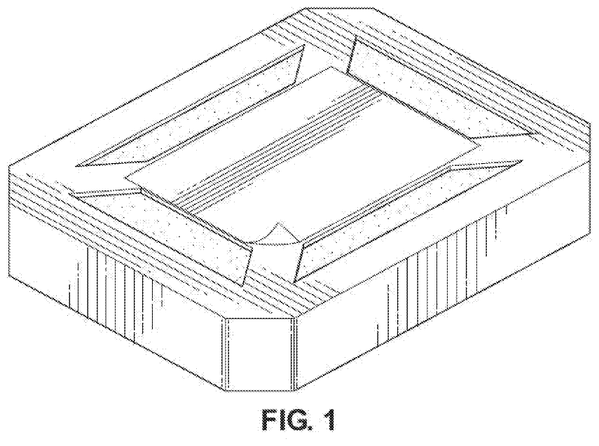

FIG. 1 illustrates a roughly rectangular shape with trimmed corners for ease of use for the artist to rotate the affixed canvass, paper, or wood medium for the artistic rendering. Adjacent to all sides of the medium are lateral ventilation cut-away vents covered by a crating to allow the spray paint to pass through. The embodiment depicts vents that are rhomboidal in shape but are not limited to that specific shape and may vary based on the embodiment. The section of this ventilation system may be constructed from various plastic or metal housing and may vary in thickness depending on the embodiment and subject to stability and ease of use of the artist. Larger artistic renderings will require a larger surface area and ventilation chamber, as well as a thick rotational board for painting.

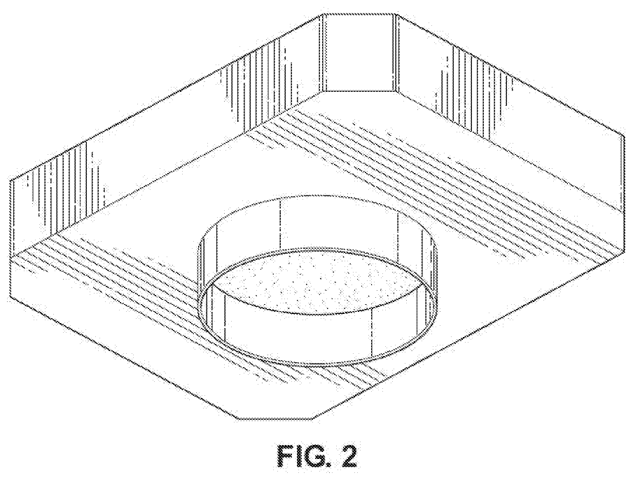

FIG. 2 illustrates the underside of the rotation artist board that creates the ventilation chamber for the air-born paint molecules to be vented away from the artist, her subject and crowd. The bottom portion of the system creates a ventilation box and secures with the top surface portion in the same roughly rectangular shape with the corners trimmed for ease of use of the artist. On the lower portion of this section a circular cut-away is attached to a raised lining of the same material as the apparatus to all the connect shape to rotate around the ventilation tubing affixed to the lower portion. FIGS. 1 and 2 when combined and attached create the secure surface for the artistic renderings as well as the ventilation box and repository for spray paint particles vented through the system via positive air pressure created from the tubing and pump motor.

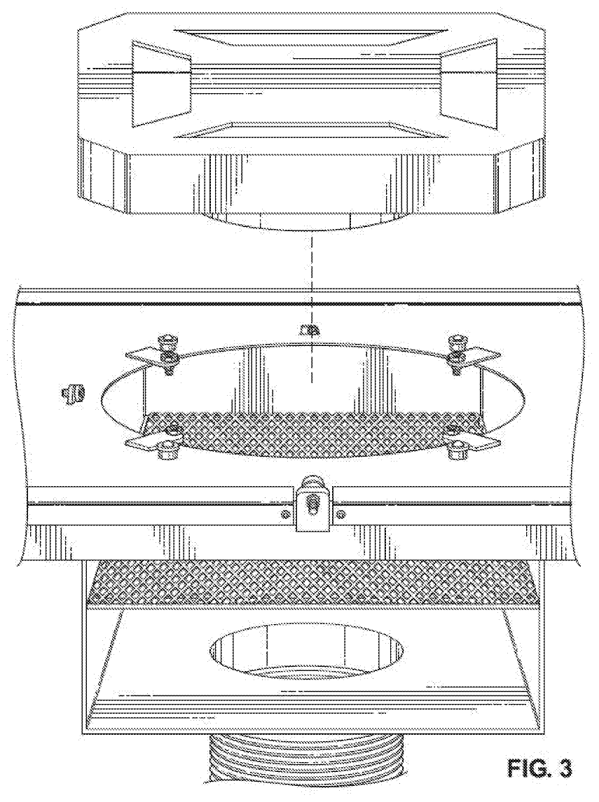

FIG. 3 depicts the second layer of the ventilation system connect to the rotation box from FIGS. 1 & 2. This is the filter layer affixed to the rotational system for the purpose of increasing the positive air pressure via the filter and collecting the paint particles within the filter during the artistic rending. The air motor engages the ventilation system and the filter layer catches or secures the air-born paint particles as the first down-stream layer and apparatus from the first collection box created by FIGS. 1 & 2. The paint filter can be a general or specific type depending on the type and quality of the paint being utilized in the spray. The apparatus may be created from various plastics, metal or wood depending on the various embodiments, and the attachment hardware shown in the diagram are standard hardware used for the various material. The configuration of the hardware is equally spaced around the circular cut-away to enable secure connection between the upper box portion and the second layer filter box depicted in FIG. 3.

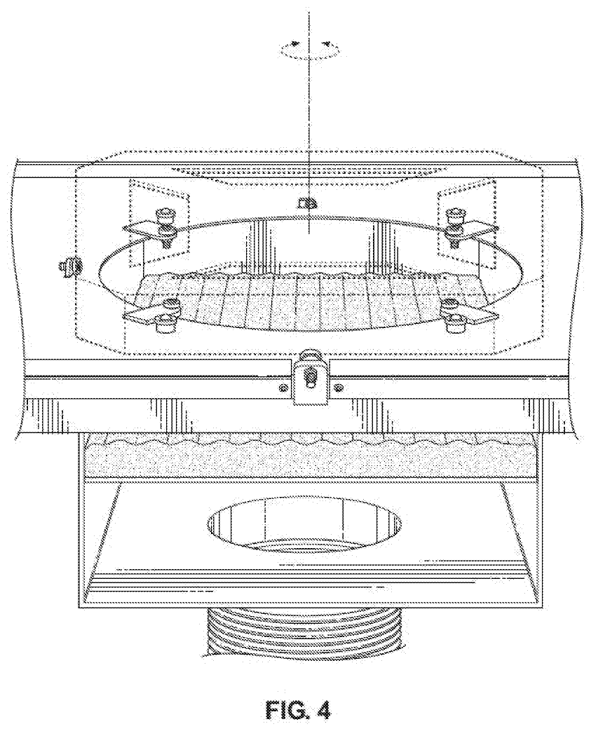

FIG. 4 illustrates the scope and size of the top layer rotational paint board and box secured to the second layer filter system. This FIG. 4 depicts the rotational axis and options for the artist to rotate the board and medium during the artist is rendering and while the ventilation system is active and engaged. Specifically, the rotation of the board does not compromise the efficiency and effectiveness of the ventilation system.

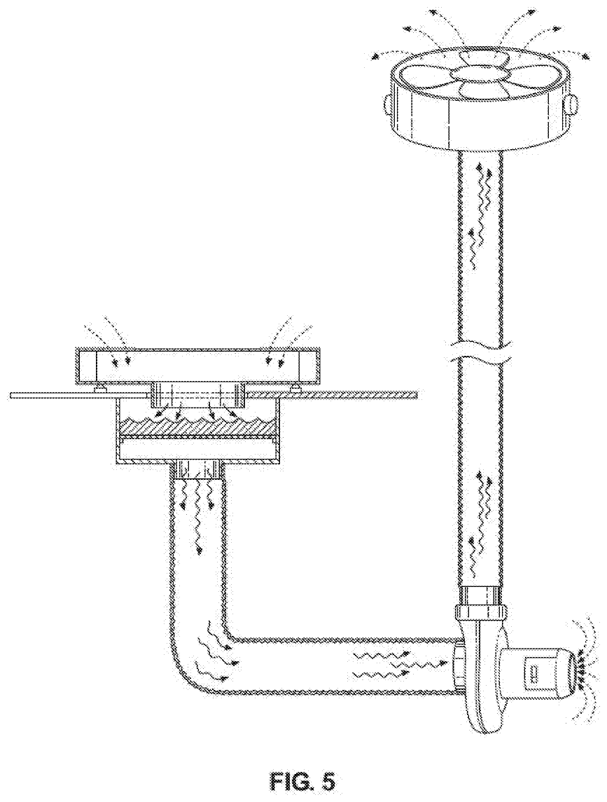

FIG. 5 adds the desired configuration for the ventilation tubing connected to a general motor to create the positive air pressure that will suck the air-born paint particles into the ventilation system, away from the artist, subject, and potential crowd. This FIG. 5 is not specific in the type of motor or exact length of tubing required, nor the specific diameter of the tubing, but rather will rely on the various embodiments and user choice of motors to configure the ventilation system with the most positive efficiency. Additionally, FIG. 5 depicts a common distribution fan at the top of the ventilation system to disperse any fumes or paint particles and traversed the entire system from the first rotation box and board, through the filter, and tubing to the egress of the system safely away from all participants. The fan and specific length of tubing form the motor is to be determined by the user and may vary according to various embodiments of the system.

Although the present invention has been described with a certain degree of particularity, it is understood that the present disclosure has been made only by way of example and that numerous changes in the details of may occur in the actual models and embodiments. A spray-painting system for renderings being painted as they are conveyed therethrough, comprising a channel having four spaced longitudinal side vents on the rotation board, ventilating air inlet means to distribute air to objects being painted, and allowing artist to rotate work as desired in a circular manner.

A ventilation chamber disposed beneath said rotation board, with said chamber having a filter to disperse and capture paint particles downwardly extending longitudinal tubing with the entire ventilation system acting on positive air pressure to create suction via an air motor at the base of the tubing connected to a final vertical tubing for vapor and particle distribution facilitated by a fan significantly spaced away from the artist and subjects.

The foregoing description merely explains and illustrates the invention and the invention is not limited thereto except insofar as the appended claims are so limited, as those skilled in the art who have the disclosure before them will be able to make modifications without departing from the scope of the invention.

We claim:

1. A spray paint system that ventilates air-born paint particles and paint fumes and rotates a painting surface.

2. Ventilation system in claim 1, comprising of a system to capture air-born paint particles and fumes and disperse said particles and fumes away from an artist, subject and others in the near vicinity.

3. Ventilation system in claim 1, comprising a spray board that rotates in a single plane in a complete circle for artistic ease of use.

4. Ventilation system in claim 1, comprising a filter system to capture air-born paint particles.

5. Ventilation system in claim 1, comprising a ventilation system to dissipate spray-paint fumes a safe distance away from artistic rendering location, specifically away from artist, subject and potential crowd.
